(19) United States
(12) Patent Application Publication
(10) Pub. No.: US 2026/0105409 A1
(43) Pub. Date: Apr. 16, 2026

(54) Truckload Analytics Methods And Systems

(71) Applicant: Echo Global Logistics, Chicago, IL (US)

(72) Inventors: Geoffrey Simmons, Presque Isle, WI (US); Scott Friesen, Oak Park, IL (US)

(21) Appl. No.: 19/323,011

(22) Filed: Sep. 9, 2025

Related U.S. Application Data
(60) Provisional application No. 63/707,489, filed on Oct. 15, 2024.

(51) Int. Cl. G06Q 10/0834; G06N 5/022; G06Q 10/083

(52) U.S. Cl. CPC G06Q 10/08345; G06N 5/022; G06Q 10/0838

(57) ABSTRACT

A method includes training, using a training process, a trained truckload quoting (TLQ) model, wherein the process includes obtaining historical truckload data representing a plurality of transported truckloads of goods, wherein, for each transported truckload, the historical truckload data includes one or more corresponding attributes of the transported truckload and a corresponding cost for the transported truckload. The method also includes adjusting one or more parameters of the TLQ model, based on the historical truckload data, to predict the corresponding costs based on the corresponding attributes. The method also includes receiving a request for a quote for transporting a particular truckload of goods, the request comprising one or more attributes of the particular truckload of goods and processing, using the trained TLQ model, the one or more attributes of the particular truckload of goods to generate a quote for transporting the particular truckload of goods.

### CROSS REFERENCE TO RELATED APPLICATION

The present application claims the filing benefits of U.S. provisional application Ser. No. 63/707,489, filed Oct. 15, 2024, which is hereby incorporated herein by reference in its entirety.

### BACKGROUND

Traditionally, shippers seeking to purchase full truckload transportation for their goods (“spot market loads”) contact and receive pricing quotes from human transportation brokers who use their knowledge and experience to estimate a cost for transporting the truckload of goods and then apply a markup.

### SUMMARY

One aspect of the disclosure provides a computer-implemented method executed on data processing hardware that causes the data processing hardware to perform operations. The operations include training, using a training process, a trained truckload quoting (TLQ) model, wherein the training process includes obtaining historical truckload data representing a plurality of transported truckloads of goods, wherein, for each transported truckload of goods of the plurality of transported truckloads of goods, the historical truckload data including one or more corresponding attributes of the transported truckload of goods, and a corresponding cost for the transported truckload of goods. The operations also include adjusting one or more parameters of the TLQ model, based on the historical truckload data, to predict the corresponding costs based on the corresponding attributes. The operations further include receiving a request for a quote for transporting a particular truckload of goods, the request including one or more attributes of the particular truckload of goods and processing, using the trained TLQ model, the one or more attributes of the particular truckload of goods to generate a quote for transporting the particular truckload of goods.

Implementations of the disclosure may include one or more of the following optional features. In some implementations, obtaining the historical truckload data includes obtaining the historical truckload data from one or more truckload management systems. In some examples, obtaining the historical truckload data includes at least one of selecting truckload data associated with a particular date period, selecting truckload data having one or more particular attributes, removing duplicate truckload data, or filtering out errant truckload data.

In some examples, adapting the one or more parameters of the trained TLQ model includes adapting one or more parameters of a generalized additive model (GAM) of the trained TLQ model. In some implementations, adapting the one or more parameters of the GAM includes applying one or more smoothers for estimating Gaussian Markov fields. In some implementations, the one or more attributes include at least one of a pickup location, a delivery location, a pickup date, a delivery date, a truck attribute, a need for special equipment, or a need for special handling. In some examples, processing, using the trained TLQ model, the one or more attributes of the particular truckload of goods to generate the quote for the transporting the particular truckload of goods includes generating, using the trained TLQ model, a distribution of costs for transporting the particular truckload of goods.

In some examples, the operations also include adjusting, using one or more rules, the quote for transporting the particular truckload of goods. The one or more rules may include at least one of, when there is an applicable repeat customer cost (RCC) rate for the particular truckload of goods, adjusting the quote to the RCC rate, when the truckload of goods analytics model is unable to generate a quote and there is an applicable rate for the particular truckload of goods, adjusting the quote to the rate, when the quote is less than a governor rate, adjusting the quote to the governor rate, applying a same lane cost (SLC) rate adjustment, applying a number of leads day rate adjustment, applying a day of week rate adjustment, or applying a holiday rate adjustment.

Another aspect of the disclosure provides a system including data processing hardware and memory hardware in communication with the data processing hardware, the memory hardware storing instructions that, when executed on the data processing hardware, cause the data processing hardware to perform operations. The operations include training, using a training process, a trained truckload quoting (TLQ) model, wherein the training process includes obtaining historical truckload data representing a plurality of transported truckloads of goods, wherein, for each transported truckload of goods of the plurality of transported truckloads of goods, the historical truckload data including one or more corresponding attributes of the transported truckload of goods, and a corresponding cost for the transported truckload of goods. The operations also include adjusting one or more parameters of the TLQ model, based on the historical truckload data, to predict the corresponding costs based on the corresponding attributes. The operations further include receiving a request for a quote for transporting a particular truckload of goods, the request including one or more attributes of the particular truckload of goods and processing, using the trained TLQ model, the one or more attributes of the particular truckload of goods to generate a quote for transporting the particular truckload of goods.

Implementations of the disclosure may include one or more of the following optional features. In some implementations, obtaining the historical truckload data includes obtaining the historical truckload data from one or more truckload management systems. In some examples, obtaining the historical truckload data includes at least one of selecting truckload data associated with a particular date period, selecting truckload data having one or more particular attributes, removing duplicate truckload data, or filtering out errant truckload data.

In some examples, adapting the one or more parameters of the trained TLQ model includes adapting one or more parameters of a generalized additive model (GAM) of the trained TLQ model. In some implementations, adapting the one or more parameters of the GAM includes applying one or more smoothers for estimating Gaussian Markov fields.

In some implementations, the one or more attributes include at least one of a pickup location, a delivery location, a pickup date, a delivery date, a truck attribute, a need for special equipment, or a need for special handling. In some examples, processing, using the trained TLQ model, the one or more attributes of the particular truckload of goods to generate the quote for the transporting the particular truckload of goods includes generating, using the trained TLQ model, a distribution of costs for transporting the particular truckload of goods.

In some examples, the operations also include adjusting, using one or more rules, the quote for transporting the particular truckload of goods. The one or more rules may include at least one of, when there is an applicable repeat customer cost (RCC) rate for the particular truckload of goods, adjusting the quote to the RCC rate, when the truckload of goods analytics model is unable to generate a quote and there is an applicable rate for the particular truckload of goods, adjusting the quote to the rate, when the quote is less than a governor rate, adjusting the quote to the governor rate, applying a same lane cost (SLC) rate adjustment, applying a number of leads day rate adjustment, applying a day of week rate adjustment, or applying a holiday rate adjustment.

### DESCRIPTION OF DRAWINGS

FIG. 1 is a schematic view of an example truckload analytics system.

FIG. 2 is a flowchart of an example arrangement of operations for a computer-implemented method of performing truckload analytics.

FIG. 3 is a flowchart of another example arrangement of operations for a computer-implemented method of performing truckload analytics.

FIG. 4 is a schematic view of an example computing device that may be used to implement the systems and methods described herein.

Like reference symbols in the various drawings indicate like elements.

### DETAILED DESCRIPTION

Traditionally, shippers seeking to purchase full truckload transportation for their goods (“spot market loads”) contact and receive pricing quotes from human transportation brokers who use their knowledge and experience to estimate a cost for transporting the truckload of goods and then apply a markup. Here, the cost is estimated because the full truckload spot market is a commodity market with no set costs that moves in time and geography every day. These cost movements are caused by constant changes in geographic and temporal supply and demand for trucks, operational conditions of the loads, as well as exogenous shocks such as weather events and pandemics. Financial risk of this activity to the firms providing transportation of goods is rooted in the fact that incorrect estimation of cost may result in paying more for the truck than the funds received from the shipper, which means that the firm loses money on the load. Overestimation of cost, meanwhile, often results in not winning the load from the shipper. In short, accurate cost estimation is a critical element of the process and seasoned truckload brokers are well compensated for these skills. The prediction of truckload costs has a series of very challenging technical aspects, most notable of which is that it is a high cardinality problem. While a transportation company that moves millions of loads per year and has cost and load detail data associated with each truckload, the per-geography, per-time, and per-operational detail volumes may be extremely sparse and difficult to generalize. Therefore, there is a need for methods and systems for performing truckload analytics to, for example, determine an appropriate quote for a particular truckload.

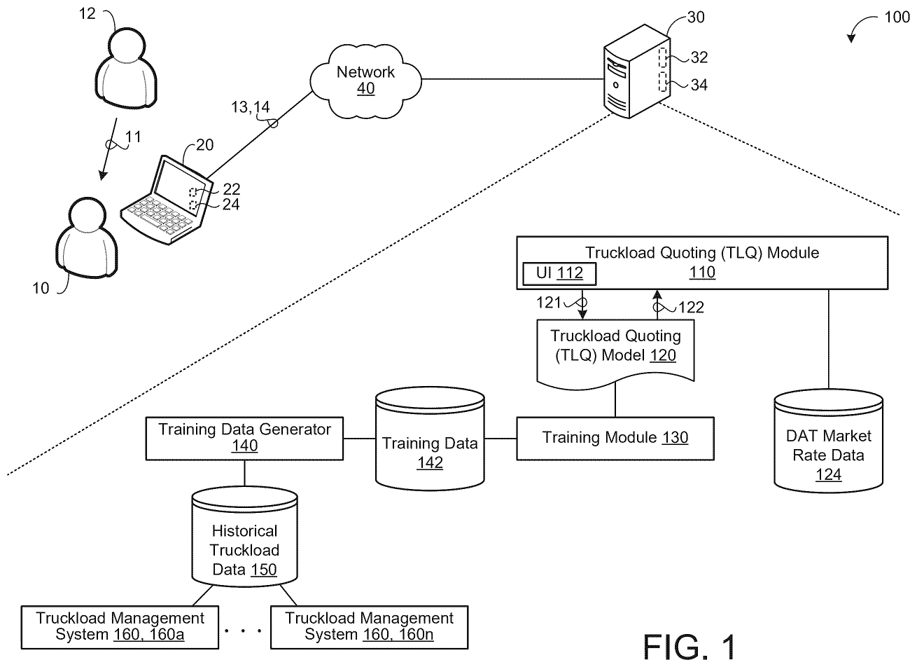

FIG. 1 is a diagram of an example of a truckload analytics system 100 for, among other purposes, dynamically generating quotes for the transportation of truckloads of goods. In the illustrated example, a person 10 receives quote requests 11, 11a-n for transporting particular truckloads of goods from customers or potential customers 12, 12a-n of a truckload transportation service provider. Here, the person 10 is an employee or contractor for the truckload transportation service provider. The quote requests 11 may be received orally or via, or from, any number and/or type(s) of user devices associated with the customers 12. The user device 20 may correspond to any computing device associated with the person 10. Some examples of user devices 20 include, but are not limited to, mobile devices (e.g., a mobile phone, a smartphone, a tablet, a laptop, etc.), computers (e.g., a laptop computer), etc. The user device 20 includes data processing hardware 22 (e.g., a processor) and memory hardware 24 (e.g., a memory) in communication with the data processing hardware 22. Here, the memory hardware 24 stores instructions that, when executed by the data processing hardware 22, cause the data processing hardware 22 to perform one or more operations, such as those disclosed herein.

To perform truckload analytics for, for example, dynamically generating quotes for the transportation of particular truckloads of goods, the truckload analytics system 100 includes a computing device 30 (e.g., a local server, a remote server, or a server of a distributed system executing in a cloud-computing environment, etc.) in communication with the user device 20 via any number and/or type(s) of public and/or private communication network(s) 40. The computing device 30 includes data processing hardware 32 (e.g., a processor), and memory hardware 34 (e.g., a memory) in communication with the data processing hardware 32. The memory hardware 34 stores instructions that, when executed by the data processing hardware 32, cause the data processing hardware 32 to perform one or more operations, such as those disclosed herein.

In the illustrated example, the computing device 30 executes a truckload quoting (TLQ) module 110 for, based on attributes of particular truckloads of goods, dynamically generating quotes 14 for the transportation of the truckloads of goods. Alternatively or additionally, the user device 20 may execute the TLQ module 110. The TLQ module 110 executes, among possibly other modules, a user interface (UI) module 112 configured to enable the user 10 to interact with the TLQ module 110 to provide a request 13 for a quote for transporting a particular truckload of goods, receive a quote 14 for transporting the particular truckload of goods, and to provide, on a display of a user device 20, the quote 14. Here, the quote request 13 contains one or more attributes of the particular truckload of goods. The TLQ module 110 may be, or include, a portion of a memory unit (e.g., the memory hardware 34) configured to store software and/or machine-or computer-readable instructions that, when executed by a processing unit (e.g., the data processing hardware 32), cause the TLQ module 110 to, based on attributes of a truckload of goods included in a request 13, generate a quote 14 for transporting the truckload of goods.

The TLQ module 110 generates quotes 14 for transporting truckloads of goods using a trained TLQ model 120. In particular, the trained TLQ module 110 generates a quote 14 for transporting a particular truckload of goods by inputting to the TLQ model 120 input data 121 that includes one or more attributes of the particular truckload of goods from a particular quote request 13. Example attributes include, but are not limited to, a pickup location, a delivery location, a pickup date, a delivery date, a truck attribute, a need for special equipment, and a need for special handling. The TLQ module 110 processes, using the TLQ model 120, the one or more attributes of the particular truckload to generate a quote 122 for transporting the particular truckload. In some examples, the TLQ model 120 generates a distribution of quotes 122, 122a-n for transporting the particular truckload of goods that represent a likelihood that a particular quote 122 of the distribution of quotes 122 is an accurate quote for transporting the particular truckload of goods based on the attributes.

In some examples, the TLQ model 120 includes a generalized additive model (GAM). The TLQ model 120 may be, or include, a portion of a memory unit (e.g., the memory hardware 34) configured to store software, and machine-or computer-readable instructions that, when executed by a processing unit (e.g., the data processing hardware 32, a graphics processing unit (GPU), a tensor processing unit (TPU), etc.), cause the TLQ model 120 to generate quotes 122 for transporting truckloads of goods.

In some implementations, the TLQ module 110 adjusts a quote 122 generated by the TLQ model 120 by applying one or more rules or heuristics. Example rules and heuristics include, but are not limited to: when there is an applicable repeat customer cost (RCC) rate for the particular truckload of goods, adjusting the quote 122 to be the RCC rate; when the TLQ model 120 is unable to generate a quote and there is an applicable rate, such as a DAT® rate (i.e., a rate provided by DAT Solutions, LLC) for the particular truckload of goods (e.g., from DAT Market Rate data 124), adjusting the quote 122 to be the DAT rate; when the quote 122 is less than a governor rate, such as a DAT governor rate, adjusting the quote 122 to be the governor rate; applying a same lane cost (SLC) rate adjustment; applying a number of leads day rate adjustment; applying a day of week rate adjustment; and/or applying a holiday rate adjustment.

In some implementations, a training process (i.e., a training module 130) trains the TLQ model 120 based on training data 142 generated, collected, obtained, etc. by a training data generator 140. The training data 142 includes historical truckload data representing a plurality of transported truckloads of goods, wherein, for each transported truckload of goods of the plurality of transported truckloads of goods, the historical truckload data includes one or more corresponding attributes of the transported truckload of goods, and a corresponding cost for the transported truckload of goods. The training process adjusts one or more parameters of the TLQ model 120, based on the training data 142, to predict the corresponding costs based on the corresponding attributes.

In the illustrated example, the training data 142 reflects an intended use case of the TLQ model 120 (e.g., “vanilla” freight, that is, no special services, cross-border, multi-stop, etc.). The training data 142 is structured for training statistical and/or machine learning models. Accordingly, the training data generator 140 scrubs the training data 142 for duplicates, assigning the correct initial cost value, filtering bad data (mismatched warehouses, mis-typed values, missing data, etc.), and enhancing the data with additional variables. In addition to the training data 142, the training data generator 140 may build reference files for additional algorithm components including repeat customer costs (RCC), same lane costs (SLC), and confidence scores. These data sets are structured via structured query language (SQL) scripts and moved via, for example, Amazon Web Services (AWS) glue from a data lake to a production AWS s3 environment, where it is loaded into a docker environment for model training and refreshing application programming interfaces (APIs).

In the illustrated example, the training data generator 140 generates the training data 142 based on historical truckload data 150 representing a plurality of transported truckloads of goods. In some examples, the historical truckload data 150 is obtained from one or more truckload management systems 160, 160a-n. The historical truckload data 150 includes, for each transported truckload of goods, one or more corresponding attributes of the transported truckload of goods, and a corresponding cost for the transported truckload of goods. Example attributes include, but are not limited to, a pickup location, a delivery location, a pickup date, a delivery date, a truck attribute, a need for special equipment, and a need for special handling. In some examples, the training data generator 140 generates the training data 142 by selecting a subset or portion of the truckload data 150. For example, the training data generator 140 may select truckload data 150 based on one or more of a particular date period and one or more truckload attributes. In some examples, the training data generator 140 filters or removes truckload data from the training data 142 to, for example, remove duplicate truckload data or filter out errant truckload data. In some implementations, on a periodic basis (e.g., daily or weekly), the training data generator 140 applies a sliding time window to select the most recent truckload data 150 and generates updated training data 142, and the training module 130 re-trains the TLQ model 120 based on the updated training data 142.

In some implementations, the training module 130 trains a generalized additive model (GAM) of the TLQ model 120. In some examples, the training module 130 leverages smoothers designed to estimate Gaussian Markov random fields (MRFs) while training the GAM.

Advantageously, by leveraging such smoothers, the TLQ model 120 can be trained in a way such that the TLQ model 120 can estimate full cost distributions, not just the most likely cost, thereby supporting a range of digital freight matching (DFM) products like “Book It Now” by making relatively low offers to carriers with the idea that only 1 out of N carriers would be expected to accept such a rate.

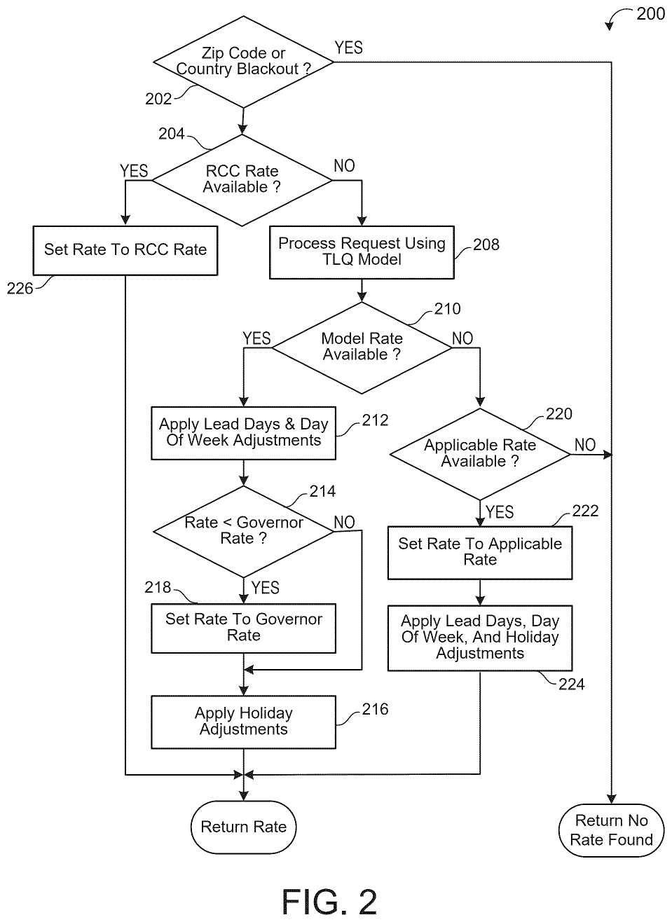

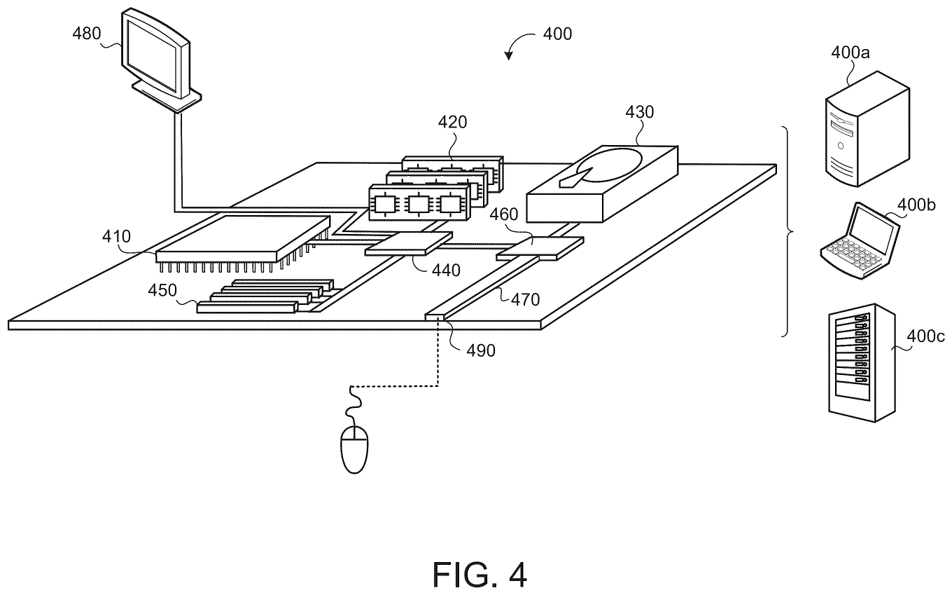

FIG. 2 is a flowchart of an exemplary arrangement of operations for a computer-implemented method 200 for generating quotes for the transportation of truckloads of goods. The operations may be performed by data processing hardware 410 (FIG. 4) (e.g., the data processing hardware 22 and/or 32) based on executing instructions stored on memory hardware 320 (e.g., the memory hardware 24 and/or 34). The method applies one or more rules or heuristics. Many other ways of implementing the method 200 may be employed. For example, the order of execution of the operations may be changed, and/or one or more of the operations and/or interactions may be changed, eliminated, sub-divided, or combined. Additionally, the operations of FIG. 2 may be carried out sequentially and/or in parallel by, for example, separate processing threads, processors, devices, discrete logic, circuits, etc.

At operation 202, the method 200 includes determining whether there is a zip code or country blackout associated with either a pickup location or destination location associated with a particular truckload of goods. If, at operation 202, there is a blackout, the method 200 returns a response that no rate (i.e., quote) was generated.

Otherwise at operation 204, the method 200 includes determining if there is an applicable RCC rate. If, at operation 204, there is not an applicable RCC rate, at operation 208, the method 200 includes processing one or more attributes of the particular truckload of goods using the TLQ model 120. At operation 210, the method 200 includes determining whether the TLQ model 120 was able to generate a rate for the particular truckload of goods. If, at operation 210, the TLQ model 120 is able to generate a rate for the particular truckload of goods, at operation 212, the method 200 applies one or more lead day or day or week rate adjustments. For example, if a short lead time is requested, or if Saturday delivery is requested.

At operation 214, the method 200 determines whether the adjusted rate is less than a governor rate (e.g., a DAT governor rate). If, at operation 214, the adjusted rate is not less than the governor rate, at operation 216, the method 200 applies one or more holiday day rate adjustments, and the adjusted rate is returned. Otherwise, at operation 218, the method 200 sets the rate to the governor rate.

Returning to operation 210, the TLQ model 120 is not able to generate a rate for the particular truckload of goods, at operation 220, the method 200 determines whether a rate (e.g., a DAT rate from DAT Market Rate data 124) is available. If, at operation 220, no rate is available, the method 200 returns a response that no rate was generated. Otherwise, at operation 222, the method 200 sets the rate to the rate. At operation 224, the method 200 applies one or more lead day, day or week, or holiday day rate adjustments, and the adjusted rate is returned.

Returning to operation 204, if there is an applicable RCC rate, at operation 226, the method 200 sets the rate to the RCC rate, and the rate is returned.

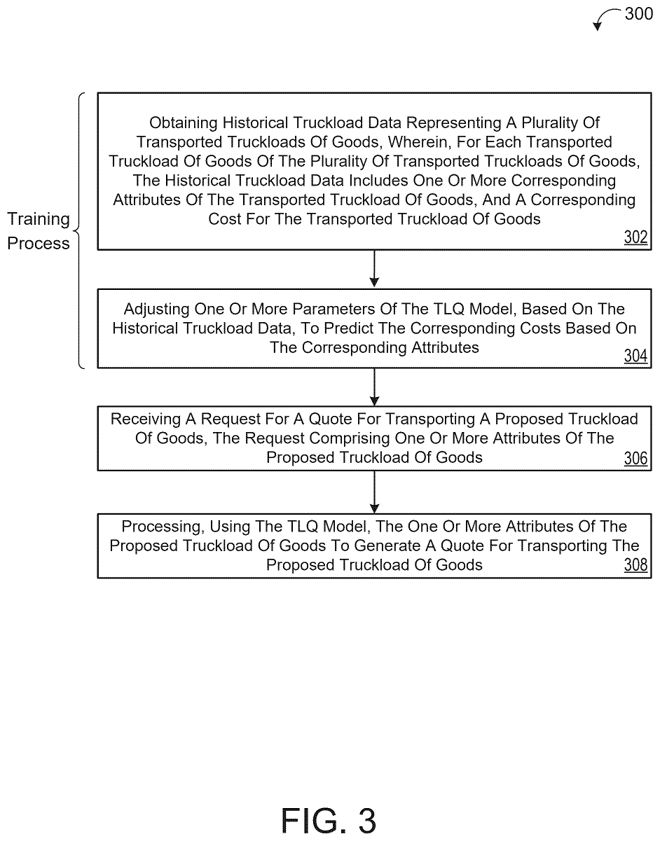

FIG. 3 is a flowchart of another exemplary arrangement of operations for a computer-implemented method 300 for generating quotes for the transportation of truckloads of goods. The operations may be performed by data processing hardware 410 (FIG. 4) (e.g., the data processing hardware 22 and/or 32) based on executing instructions stored on memory hardware 320 (e.g., the memory hardware 24 and/or 34). Many other ways of implementing the method 300 may be employed. For example, the order of execution of the operations may be changed, and/or one or more of the operations and/or interactions may be changed, eliminated, sub-divided, or combined. Additionally, the operations of FIG. 3 may be carried out sequentially and/or in parallel by, for example, separate processing threads, processors, devices, discrete logic, circuits, etc.

The method 300 includes training, using a training process 130, a truckload quoting (TLQ) model 120. At operation 302, the method 300 includes obtaining historical truckload data 150 representing a plurality of transported truckloads of goods, wherein, for each transported truckload of goods of the plurality of transported truckloads of goods, the historical truckload data 150 includes one or more corresponding attributes of the transported truckload of goods, and a corresponding cost for the transported truckload of goods. At operation 304, the method 300 includes adjusting one or more parameters of the TLQ model 120, based on the historical truckload data 150, to predict the corresponding costs based on the corresponding attributes.

At operation 306, the method 300 includes receiving a quote request 13 for transporting a particular truckload of goods, the quote request 13 including one or more attributes of the particular truckload of goods. At operation 308, the method 300 includes processing, using the TLQ model 120, the one or more attributes of the particular truckload of goods to generate a quote 14 for transporting the particular truckload of goods.

FIG. 4 is a schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (i.e., data processing hardware) that can be used to implement the data processing hardware 22 and/or 42, memory 420 (i.e., memory hardware) that can be used to implement the memory hardware 24 and/or 44, a storage device 430 (i.e., memory hardware) that can be used to implement the memory hardware 24 and/or 44, or the data 124, 142, and/or 150, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
training, using a training process, a trained truckload quoting (TLQ) model, wherein the training process comprises:
obtaining historical truckload data representing a plurality of transported truckloads of goods, wherein, for each transported truckload of goods of the plurality of transported truckloads of goods, the historical truckload data comprises:
one or more corresponding attributes of the transported truckload of goods; and
a corresponding cost for the transported truckload of goods; and
adjusting one or more parameters of the TLQ model, based on the historical truckload data, to predict the corresponding costs based on the corresponding attributes;
receiving a request for a quote for transporting a particular truckload of goods, the request comprising one or more attributes of the particular truckload of goods; and
processing, using the trained TLQ model, the one or more attributes of the particular truckload of goods to generate a quote for transporting the particular truckload of goods.

2. The computer-implemented method of claim 1, wherein obtaining the historical truckload data comprises obtaining the historical truckload data from one or more truckload management systems.

3. The computer-implemented method of claim 2, wherein obtaining the historical truckload data comprises at least one of:
selecting truckload data associated with a particular date period;
selecting truckload data having one or more particular attributes;
removing duplicate truckload data; or
filtering out errant truckload data.

4. The computer-implemented method of claim 1, wherein adapting the one or more parameters of the trained TLQ model comprises adapting one or more parameters of a generalized additive model (GAM) of the trained TLQ model.

5. The computer-implemented method of claim 4, wherein adapting the one or more parameters of the GAM comprises applying one or more smoothers for estimating Gaussian Markov fields.

6. The computer-implemented method of claim 1, wherein the one or more attributes include at least one of:
a pickup location;
a delivery location;
a pickup date;
a delivery date;
a truck attribute;
a need for special equipment; or
a need for special handling.

7. The computer-implemented method of claim 1, wherein processing, using the trained TLQ model, the one or more attributes of the particular truckload of goods to generate the quote for the transporting the particular truckload of goods comprises generating, using the trained TLQ model, a distribution of costs for transporting the particular truckload of goods.

8. The computer-implemented method of claim 1, wherein the operations further comprise adjusting, using one or more rules, the quote for transporting the particular truckload of goods.

9. The computer-implemented method of claim 8, wherein the one or more rules comprise at least one of:
when there is an applicable repeat customer cost (RCC) rate for the particular truckload of goods, adjusting the quote to the RCC rate;
when the truckload of goods analytics model is unable to generate a quote and there is an applicable rate for the particular truckload of goods, adjusting the quote to the rate;
when the quote is less than a governor rate, adjusting the quote to the governor rate;
applying a same lane cost (SLC) rate adjustment;
applying a number of leads day rate adjustment;
applying a day of week rate adjustment; or
applying a holiday rate adjustment.

10. A system comprising:
data processing hardware; and
memory hardware in communication with the data processing hardware, the memory hardware storing instructions that, when executed on the data processing hardware, cause the data processing hardware to perform operations comprising
training, using a training process, a trained truckload quoting (TLQ) model, wherein the training process comprises:
obtaining historical truckload data representing a plurality of transported truckloads of goods, wherein, for each transported truckload of goods of the plurality of transported truckloads of goods, the historical truckload data comprises:
one or more corresponding attributes of the transported truckload of goods; and
a corresponding cost for the transported truckload of goods; and
adjusting one or more parameters of the TLQ model, based on the historical truckload data, to predict the corresponding costs based on the corresponding attributes;
receiving a request for a quote for transporting a particular truckload of goods, the request comprising one or more attributes of the particular truckload of goods; and
processing, using the trained TLQ model, the one or more attributes of the particular truckload of goods to generate a quote for transporting the particular truckload of goods.

11. The system of claim 10, wherein obtaining the historical truckload data comprises obtaining the historical truckload data from one or more truckload management systems.

12. The system of claim 11, wherein obtaining the historical truckload data comprises at least one of:
selecting truckload data associated with a particular date period;
selecting truckload data having one or more particular attributes;
removing duplicate truckload data, or
filtering out errant truckload data.

13. The system of claim 10, wherein adapting the one or more parameters of the trained TLQ model comprises adapting one or more parameters of a generalized additive model (GAM) of the trained TLQ model.

14. The system of claim 13, wherein adapting the one or more parameters of the GAM comprises applying one or more smoothers for estimating Gaussian Markov fields.

15. The system of claim 10, wherein the one or more attributes include at least one of:
a pickup location;
a delivery location;
a pickup date;
a delivery date;
a truck attribute;
a need for special equipment; or
a need for special handling.

16. The system of claim 10, wherein processing, using the trained TLQ model, the one or more attributes of the particular truckload of goods to generate the quote for the transporting the particular truckload of goods comprises generating, using the trained TLQ model, a distribution of costs for transporting the particular truckload of goods.

17. The system of claim 10, wherein the operations further comprise adjusting, using one or more rules, the quote for transporting the particular truckload of goods.

18. The system of claim 17, wherein the one or more rules comprise at least one of:
when there is an applicable repeat customer cost (RCC) rate for the particular truckload of goods, adjusting the quote to the RCC rate;
when the truckload of goods analytics model is unable to generate a quote and there is an applicable rate for the particular truckload of goods, adjusting the quote to the rate;
when the quote is less than a governor rate, adjusting the quote to the governor rate;
applying a same lane cost (SLC) rate adjustment;
applying a number of leads day rate adjustment;
applying a day of week rate adjustment; or
applying a holiday rate adjustment.
